(19) United States
(12) Patent Application Publication
(10) Pub. No.: US 2008/0032111 A1
(43) Pub. Date: Feb. 7, 2008

(54) FLAT GLASS AND PROCESS FOR PRODUCING THE FLAT GLASS

(75) Inventors: Toru Kamihori, Yokohama-shi (JP); Motoichi Iga, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 11/868,125

(22) Filed: Oct. 5, 2007

Related U.S. Application Data
(63) Continuation of application No. PCT/JP2006/307678, filed on Apr. 11, 2006.

(30) Foreign Application Priority Data
Apr. 12, 2005 (JP) 2005-114977
Jun. 16, 2005 (JP) 2005-176682

(51) Int. Cl. C03B 13/00; C03B 18/02; B32B 27/32

(52) U.S. Cl. 428/220; 65/91; 65/99.2; 65/99.5

(57) ABSTRACT

The present invention provides a flat glass capable of improving influence on visibility for use in FPD (Flat Panel Display) such as liquid crystal etc. and a process for producing the same. The flat glass has a sheet thickness of from 0.1 to 1.1 mm, especially from 0.3 to 1.1 mm and contains bubbles of 100 to 1,000 μm in major axis wherein the ratio of minor axis/major axis is 0.85 or greater. This flat glass is produced by forming a molten glass ribbon to a sheet thickness of over 1.0 to 1.5 times a predetermined sheet thickness t of from 0.1 to 1.1 mm under a molten glass ribbon viscosity of log η≦5, and thereafter forming the molten glass ribbon to the predetermined sheet thickness t under a molten glass ribbon viscosity of 5<log η≦7.65.

### TECHNICAL FIELD

The present invention relates to a flat glass produced by a float method and a process for producing such flat glass. In particular, it relates to a flat glass for FPD (Flat Panel Display) such as liquid crystal etc.

### BACKGROUND ART

Apparatus for producing a flat glass with use of a float method is such one that molten glass is supplied successively onto molten tin received in a bath to form a molten glass ribbon, which is advanced on the molten tin in a floating state, and when it reaches or is about to reach an equilibrium thickness (about 7 mm) or it has a thickness of the equilibrium thickness or more, the molten glass ribbon is pulled toward a lehr (a cooling part located at a downstream side) adjacent to an outlet port of the molten tin bath, so that a strip-like flat glass having a predetermined width is produced.

In this case, it is impossible to form a flat glass for FPD having a sufficiently thin thickness (from 0.1 to 1.1 mm, especially, from 0.3 to 1.1 mm) unless one takes measures other than pulling simply the molten glass ribbon on the molten tin toward the lehr. For this, in the apparatus for producing a flat glass disclosed in, for example, Patent Document 1, a molten glass ribbon having reached an equilibrium thickness on the molten tin is pulled toward the lehr while upper surfaces of both side edges of the molten glass ribbon are pulled (are retained) in its width direction by means of rotating edge rollers, whereby a thin flat glass usable for FDP can be produced.

Patent document 1: JP-A-11-236231

### DISCLOSURE OF THE INVENTION

### Problems to be Solved by the Invention

In recent years, liquid crystal displays have been of high precision. It has been found that bubbles contained in a flat glass for use in FPD influence on visibility to a picture image depending on sizes and shapes of the bubbles. The flat glass produced by the manufacturing apparatus with the edge rollers as in Patent Document 1, however, contained bubbles in a form of elongated ball, like a rugby ball, each having a very short minor axis with respect to a major axis, in the direction of lehr to which the molten glass ribbon was fed. These bubbles in a form of elongated ball affected visibility to picture images.

The present invention has been made in view of such problem and is to provide a flat glass capable of improving visibility when used for FPD and a process for producing such flat glass.

### Means of Solving the Problems

In order to achieve the above-mentioned object, the present invention is to provide a flat glass having a sheet thickness of from 0.1 to 1.1 mm and containing bubbles having a major axis of from 100 to 1,000 μm wherein the ratio of minor axis/major axis of the bubbles is 0.85 or greater.

Further, in order to achieve the above-mentioned object, the present invention is to provide a flat glass having a sheet thickness of from 0.3 to 1.1 mm and containing bubbles having a major axis of from 100 to 1,000 μm wherein the ratio of minor axis/major axis of the bubbles is 0.85 or greater.

Numerical values of the flat glass of the present invention will be explained. A sheet thickness of from 0.1 to 1.1 mm, especially from 0.3 to 1.1 mm is required for a flat glass for FPD, produced by a float method, and accordingly, a cast glass of larger thickness used as architectural material or the like, formed by, for example, a rolling process does not fall in this category. The sizes of bubble that may influence on visibility will be explained. When the size of bubble exceeds 1,000 μm in major axis, the visibility to a picture image deteriorates because the size is too large in spite of a shape of bubble. This was verified by a visual check to picture images when a flat glass is used for FPD. On the other hand, when the size of bubble is less than 100 μm in major axis, influence on visibility to picture images is less because the size of bubble is small in spite of a shape of bubble. This was verified by a visual check to picture images.

The bubbles that may affect visibility to a picture image, are those having a major axis of from 100 to 1,000 μm and a ratio of minor axis/major axis of less than 0.85. It was verified by a visual check to picture images that such bubbles were apt to affect the visibility.

Accordingly, the flat glass of the present invention, which has a sheet thickness of from 0.1 to 1.1 mm, especially, from 0.3 to 1.1 mm and contains bubbles having a major axis of from 100 to 1,000 μm wherein the ratio of minor axis/major axis of the bubbles is 0.85 or greater, has less influence on visibility when used for FPD.

In order to achieve the above-mentioned object, the present invention provides a process for producing a flat glass which comprises forming a molten glass ribbon to a sheet thickness of 1.0<t≦1.5 (a sheet thickness of over 1.0 to 1.5 times a predetermined sheet thickness t, hereinafter, it is the same as this) times a predetermined sheet thickness t of from 0.1 to 1.1 mm under a molten glass ribbon viscosity of log η≦5, and thereafter forming the molten glass ribbon to the predetermined sheet thickness t of from 0.1 to 1.1 mm under a molten glass ribbon viscosity of 5<log η≦7.65.

Further, in order to achieve the above-mentioned object, the present invention provides a process for producing a flat glass which comprises forming a molten glass ribbon to a sheet thickness of 1.0<t≦1.5 times a predetermined sheet thickness t of from 0.3 to 1.1 mm under a molten glass ribbon viscosity of log η≦5, and thereafter forming the molten glass ribbon to the predetermined sheet thickness t of from 0.3 to 1.1 mm under a molten glass ribbon viscosity of 5<log η≦7.

Here, explanation will be made as to the relation of bubbles contained in the flat glass to the viscosity of the molten glass ribbon. When the viscosity of a molten glass ribbon was log η≦5 (the state of viscosity log η≦5 signifies a viscosity η=10⁵ dPa·s), namely, in a state of nearly liquid, the bubbles contained in the molten glass ribbon maintained a state of substantially true round due to surface tension even though the ribbon was stretched in a direction of the lehr, according to verification conducted by us. However, in order to form the molten glass ribbon to a sheet thickness of from 0.1 to 1.1 mm, especially from 0.3 to 1.1 mm, it was necessary to pull it in a direction of the lehr while the glass ribbon was controlled with edge rollers so as to have a predetermined length in its width direction. For this, in a state that the viscosity log η of the molten glass ribbon exceeded 5, i.e., in a state that the viscosity became high, the molten glass ribbon should be stretched in a direction of the lehr while the width of the ribbon was secured. As a result, the bubbles contained in the ribbon were also stretched to be in elongated balls like rugby balls. Namely, the conventional flat glass manufacturing apparatus with edge rollers is so constructed that a molten glass ribbon having a viscosity of 5<log η≦7.65 (the value 7.65 corresponds to the viscosity at the glass softening temperature), preferably, a viscosity of 5<log η≦7, in other words, a molten glass ribbon having an equilibrium thickness (7 mm) or more is stretched in a direction of the lehr while both side edges of the ribbon are controlled with the edge rollers so that it is formed to a sheet thickness of from 0.1 to 1.1 mm, especially from 0.3 to 1.1 mm. Accordingly, the bubbles were in a shape of extremely elongated ball and they might affect the visibility.

According to a process for producing a flat glass of the present invention, a molten glass ribbon is formed to a sheet thickness of 1.0<t≦1.5 times a predetermined sheet thickness t of from 0.1 to 1.1 mm, especially from 0.3 to 1.1 mm under a molten ribbon viscosity of log η≦5, and thereafter, to the predetermined sheet thickness t (from 0.1 to 1.1 mm, especially, from 0.3 to 1.1 mm) under a molten glass ribbon viscosity of 5<log η≦7.65, preferably, 5<log η≦7. Accordingly, there is little possibility that the bubbles are stretched, and they keep a substantially true round shape. Further, the flat glass produced by this manufacturing process has a sheet thickness of from 0.1 to 1.1 mm, especially, from 0.3 to 1.1 mm and contains bubbles having a major axis of from 100 to 1,000 μm wherein the ratio of minor axis/major axis of the bubbles is 0.85 or greater. Therefore, influence on visibility is low when such glass is used for FPD. When the viscosity is log η>7, especially log η>7.65, the molten glass ribbon solidifies to lose plasticity. Accordingly, the molten glass ribbon should be formed to a predetermined sheet thickness under a condition that the viscosity is 5<log η≦7.65, preferably 5<log η≦7. In this text, the true round shape includes a flattened round shape.

The present invention is to provide the process for producing a flat glass as mentioned above, in which a float method is utilized and which comprises pulling, toward the lehr, a molten glass ribbon retaining both side edges of the ribbon so as to oppose a contractive force due to the surface tension of the ribbon on a molten metal under a molten glass ribbon viscosity of log η≦5, to thereby form it to a sheet thickness of 1.0<t≦1.5 times the predetermined sheet thickness t of from 0.1 to 1.1 mm, and thereafter pulling the ribbon successively, toward the lehr, retaining the both side edges of the ribbon under a molten glass ribbon viscosity of from 5<log η≦7.65 to thereby form it to the predetermined thickness t. Use of the float method permits production of a flat glass for a large-sized FPD in a stable manner.

Further, the present invention is to provide the process for producing a flat glass as mentioned above, in which a float method is utilized and which comprises pulling, toward the lehr, a molten glass ribbon retaining both side edges of the ribbon so as to oppose a contractive force due to the surface tension of the ribbon on a molten metal under a molten glass ribbon viscosity of log η≦5, to thereby form it to a sheet thickness of 1.0<t≦1.5 times the predetermined sheet thickness t of from 0.3 to 1.1 mm, and thereafter pulling the ribbon successively, toward the lehr, retaining the both side edges of the ribbon under a molten glass ribbon viscosity of from 5<log η≦7 to thereby form it to the predetermined thickness t. Use of the float method permits production of a flat glass for a large-sized FPD in a stable manner.

The present invention is to provide the process for producing a flat glass using a float method as mentioned above, wherein in retaining the side edges of the ribbon, recessed portions are formed at the bath surface of the molten metal by sucking the molten metal in its substantially vertical direction along the both side edges of the molten glass ribbon so that the both side edges of the ribbon fit into the recessed portions.

The present invention is to provide a process for producing a flat glass, which comprises pulling, toward a lehr, a molten glass ribbon retaining both side edges of the ribbon at the recessed portions formed in the bath surface of a molten metal so as to oppose a contractive force due to the surface tension of the ribbon on the molten metal under a molten glass ribbon viscosity of log η≦5, to thereby form it to a sheet thickness of 1.0<t≦1.5 times a predetermined sheet thickness t of from 0.1 to 1.1 mm, especially from 0.3 to 1.1 mm, and thereafter pulling the ribbon successively, toward the lehr, retaining the both side edges of the ribbon under a molten glass ribbon viscosity of from 5<log η≦7.65, preferably 5<log η≦7 to thereby form it to the predetermined thickness t. By utilizing such process, a flat glass which has a sheet thickness of from 0.1 to 1.1 mm, especially, from 0.3 to 1.1 mm and contains bubbles having a major axis of from 100 to 1,000 μm wherein the ratio of minor axis/major axis of the bubbles is 0.85 or greater can be produced. Use of any of the processes according to the present invention permits production of a flat glass of stable quality for a large-sized FPD.

### EFFECTS OF THE INVENTION

According to the flat glass of the present invention, it has a sheet thickness of from 0.1 to 1.1 mm, especially, from 0.3 to 1.1 mm and contains bubbles having a major axis of from 100 to 1,000 μm wherein the ratio of minor axis/major axis of the bubbles is 0.85 or greater. Accordingly, when it is used for FPD, the influence on visibility is low.

According to a process for producing a flat glass of the present invention, a molten glass ribbon is formed to a sheet thickness of 1.0<t≦1.5 times a predetermined sheet thickness t of from 0.1 to 1.1 mm, especially from 0.3 to 1.1 mm under a molten glass ribbon viscosity of log η≦5, and thereafter, to the predetermined sheet thickness t under a molten glass ribbon viscosity of 5<log η≦7.65, preferably 5<log η≦7. Accordingly, it is possible to form a flat glass capable of improving visibility when used for FPD.

### BRIEF DESCRIPTION OF THE DRAWINGS

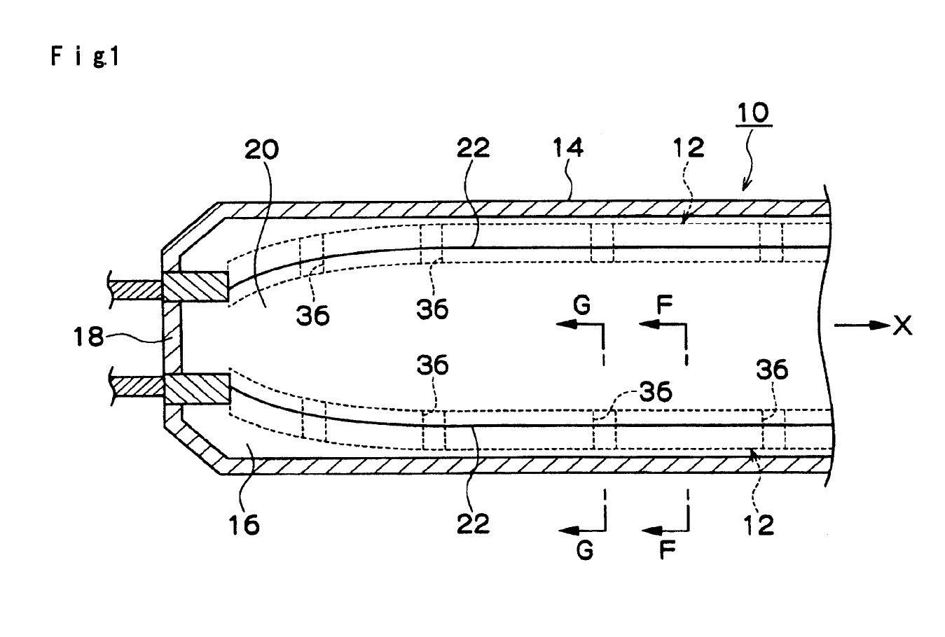

(FIG. 1) A plan view showing an apparatus for producing a flat glass according to an embodiment of the present invention.

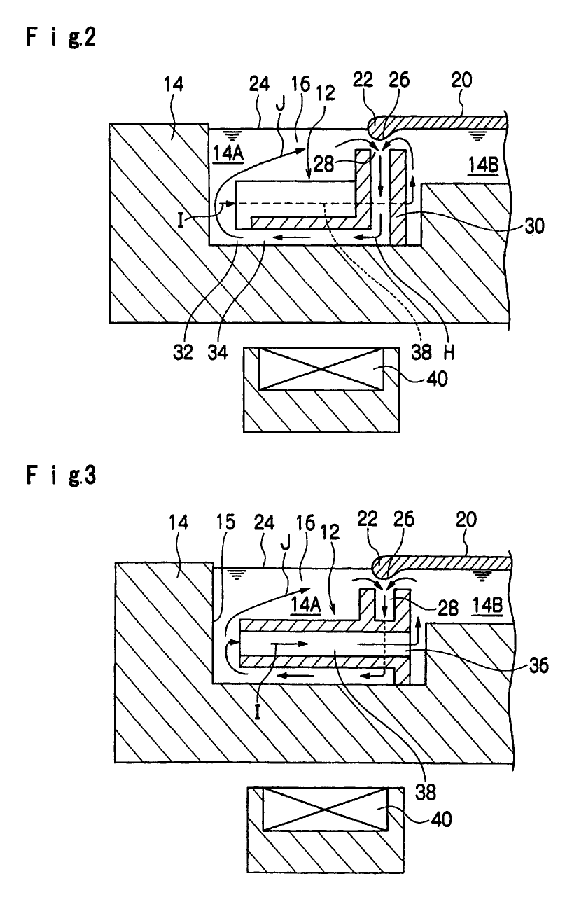

(FIG. 2) A cross-sectional view of the gutter-like member viewed from the section of F-F line in FIG. 1.

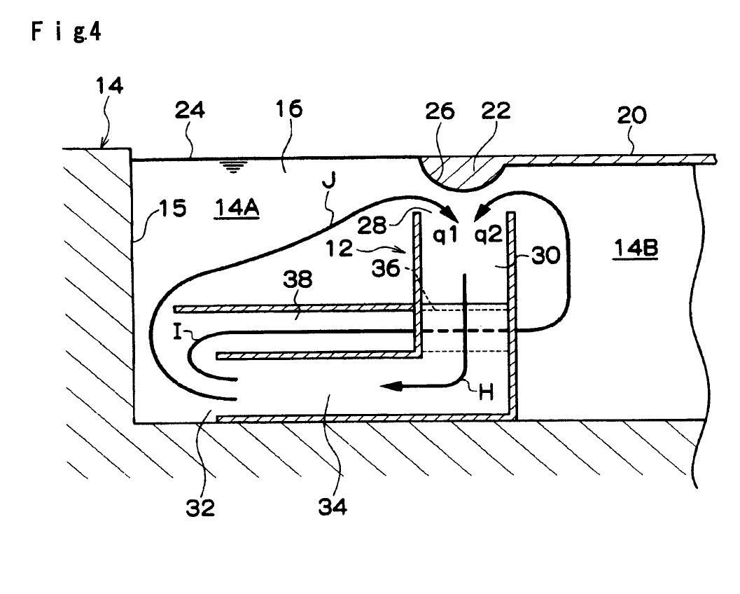

(FIG. 3) A cross-sectional view of the gutter-like member viewed from the section of G-G line in FIG. 1.

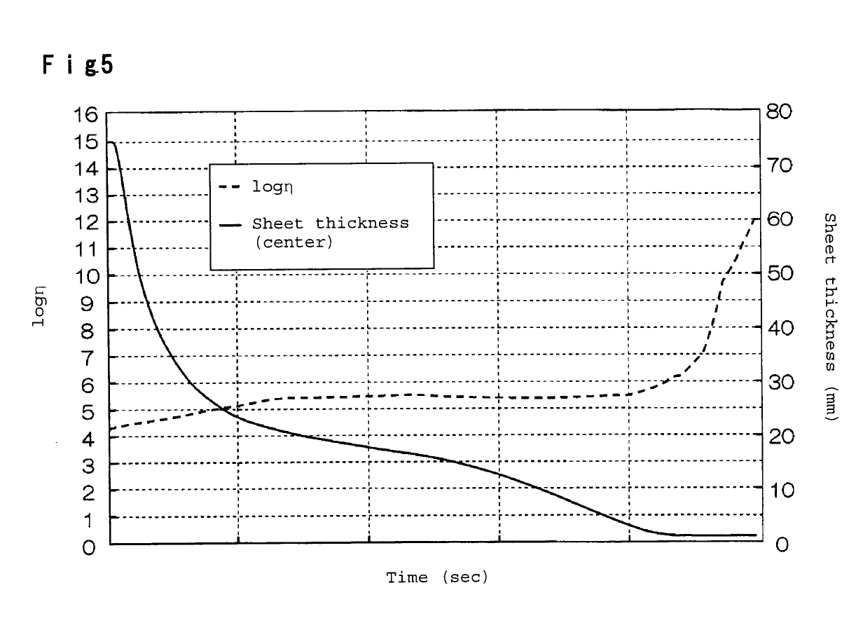

(FIG. 4) An enlarged cross-sectional view of the gutter-like member shown in FIG. 2 or FIG. 3.

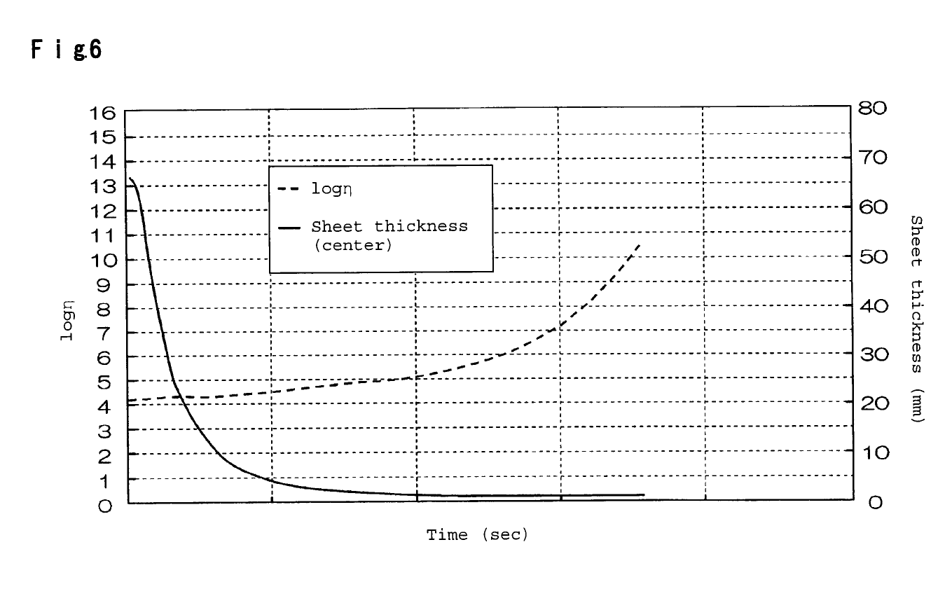

(FIG. 5) A diagram showing the relation between a viscosity and a sheet thickness of a molten glass ribbon in connection with a time axis according to a conventional method for producing a flat glass.

(FIG. 6) A diagram showing the relation between a viscosity and a sheet thickness of a molten glass ribbon in connection with a time axis according to the process for producing a flat glass in accordance with an embodiment of the present invention.

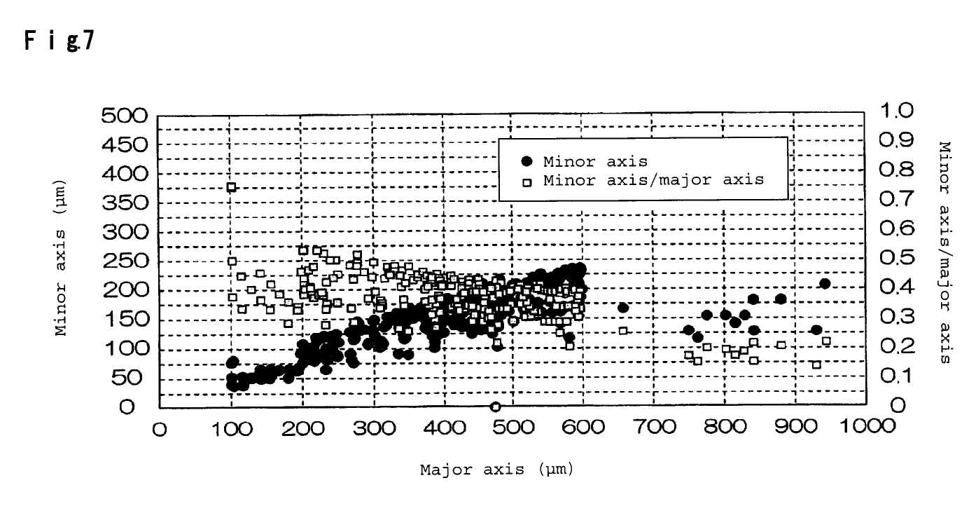

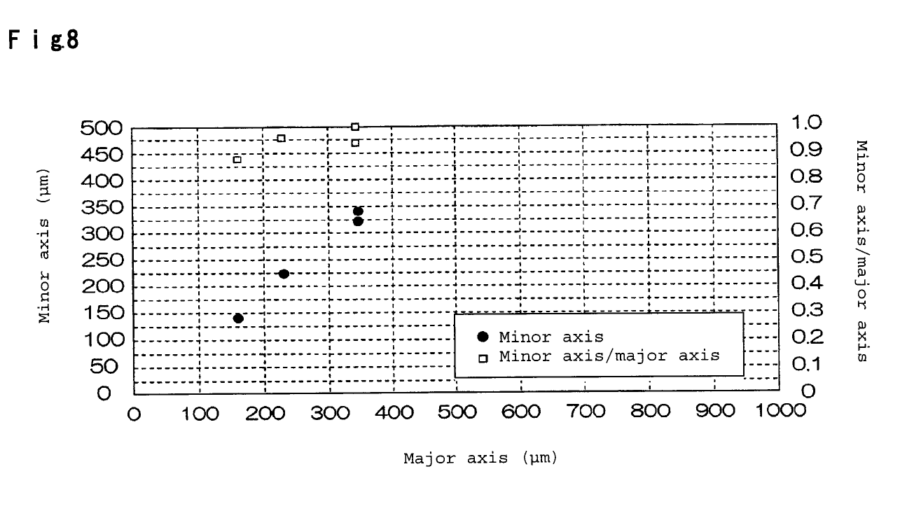

(FIG. 7) A diagram showing the relation between a minor axis and a ratio of minor axis/major axis of a flat glass in connection with a major axis, produced according to a conventional method for producing a flat glass.

(FIG. 8) A diagram showing the relation between a minor axis and a ratio of minor axis/major axis of a flat glass in connection with a major axis, produced according to the process for producing a flat glass in accordance with an embodiment of the present invention.

### MEANINGS OF SYMBOLS

10: Flat glass manufacturing apparatus, 12: gutter-like member, 14: bath, 16: molten tin, 18: supply port, 20: molten glass ribbon, 22: edge, 24: bath surface, 26: recessed portion, 28: inlet port, 30: longitudinal passage, 32: outlet port, 34: lateral passage, 36: through-hole, 38: circulation passage, 40: linear motor

### BEST MODE FOR CARRYING OUT THE INVENTION

In the following, description will be made as to a preferred embodiment of the flat glass and the process for producing such flat glass according to the present invention, with reference to attached drawing.

FIG. 1 is a plan view of a flat glass manufacturing apparatus 10 for producing a flat glass using a float method. A flat glass used for FPD is generally required to have a sheet thickness of from about 0.1 to 1.1 mm, especially, from 0.3 to 1.1 mm, and also, is required to have a high precision in flatness. For the flat glass manufacturing apparatus 10, a flat glass manufacturing apparatus 10 equipped with a gutter-like member 12 is employed. With such flat glass manufacturing apparatus 10, a flat glass satisfying a sheet thickness and flatness required for a flat glass for FPD can be produced.

The gutter-like member 12 of the flat glass manufacturing apparatus 10 is disposed in a bath 14 to be dipped in molten tin (molten metal) 16 received in the bath 14 and is disposed along both side edges 22, 22 of a molten glass ribbon 20 supplied continuously from a molten glass furnace through a supply port 18 to the bath 14. The molten glass ribbon 20 is advanced by a pulling force in a direction of lehr (a direction of X in FIG. 1) on the bath surface of the molten tin 16 while the edges 22, 22 are retained at recessed portions 26 formed in the bath surface 24. The molten glass ribbon 20 whose edges 22 are retained by the recessed portions 26 is subjected to adjustments to the thickness and the width and then, is fed in a stable state to a rear part of the bath where it is cooled to be supplied to the lehr.

Glass used in this embodiment is non-alkali glass, sodalime glass or the like. The molten tin 16 and the glass ribbon 20 are heated with electrical heaters (not shown). In this case, the molten glass ribbon 20, when the viscosity of the ribbon 20 is log η≦5, is formed to a sheet thickness of 1.0<t≦1.5 times a predetermined sheet thickness t of from 0.1 to 1.1 mm, especially from 0.3 to 1.1 mm, as described later, and thereafter, the ribbon is formed to the predetermined thickness t under a viscosity of 5<log η≦7.65, preferably 5<log η≦7. The glass viscosity is adjusted by controlling heating temperature (when several conditions of temperature are exemplified for some kinds of glass having certain different compositions, under log η≦5, a predetermined temperature range of from 1,000 to 1,500° C. is set for non-alkali glass and a predetermined temperature range of from 930 to 1,300° C. is set for sodalime glass and under 5<log η≦7, a predetermined temperature range of from 850 to 1,000° C. is set for non-alkali glass and a predetermined temperature range of from 800 to 930° C. is set for sodalime glass), and the sheet thickness is adjusted by controlling the pulling rate in a direction of lehr and the retaining force to the edges (i.e., a force of sucking tin).

FIG. 2 is a cross-sectional view taken along a F-F line in FIG. 1 and FIG. 3 is a cross-sectional view taken along a G-G line in FIG. 1. As shown in these Figures, the gutter-like member 12 is formed to have a substantially L-like shape in cross section and comprises a longitudinal passage 30 with an inlet port 28, a lateral passage 34 (FIG. 2) with an outlet port 32 and a circulation passage 38 (FIG. 3) with a through-hole 36 formed at a position corresponding to the longitudinal passage 30.

A linear motor 40 is located below the bottom portion of the bath 14 so as to correspond to a lateral passage 34 of the gutter-like member 12. By the action of the linear motor 40, a driving force is given to the molten tin 16 in the lateral passage 34 so that the molten tin 16 is driven in the direction indicated by an arrow mark H in the longitudinal passage 30 and the lateral passage 34 of the gutter-like member 12.

This flow of the molten tin creates a flow of molten tin 16 in a direction substantially perpendicular to the bath surface 24 toward the bottom of the bath 14. Accordingly, a negative pressure is produced below the edge 22 of the molten glass ribbon 20 so that the level of the bath surface of the molten tin 16 is lowered at the edge 22 with respect to the bath surface level around the edge 22. Then, the edge 22 of the molten glass ribbon 20 fit into the recessed portion 26 of the bath surface 24 lowered by the negative pressure. Since the edge 22 of the molten glass ribbon 20 is retained by this recessed portion 26, the contraction of the molten glass ribbon 20 in the width direction can be prevented. By pulling the molten glass ribbon in the direction of lehr while the dimension of the ribbon in its width direction is retained, a flat glass having a thinner sheet thickness than an equilibrium thickness (a predetermined thickness of from 0.1 to 1.1 mm, especially, from 0.3 to 1.1 mm) can be produced.

The material of the gutter-like member 12 may be of low reactivity or non reactivity to the molten tin 16 or of high-temperature-tolerant, such as alumina, silimanite, clayish brick or carbon. In this embodiment using the linear motor 40, carbon is employed since it is necessary for the gutter-like member 12 to be made of a non-magnetic substance so as to exert a magnetic field to the gutter-like member, and the carbon has good workability because a large-sized gutter-like member is employed.

The linear motor 40 has advantages that the molten tin 16 can be driven directly in a non-contact state and it is easy to control the flow rate. The linear motor 40 generates a magnetic field moving in a certain direction by applying an A.C. voltage to coils wound around a comb-like primary iron core and by magnetizing sequentially these coils. This linear motor 40 is located below the bottom surface of the bath at a position that a driving force (an urging force) acts on the molten tin 16 in the lateral passage 34 of the gutter-like member 12. By locating the linear motor 40 at such specified position, the molten tin 16 in the longitudinal passage 30 and the lateral passage 34 flows from the area just below the edge 22 of the molten glass ribbon 20 toward a side wall 15 of the bath 14 as indicated by the arrow mark H, due to the driving force of the linear motor 40.

The gutter-like member 12 has the circulation passage 38 other than the longitudinal passage 30 and the lateral passage 34. This circulation passage 38 is communicated with a portion 14B, which is on the side of the center of the bath with respect to the edge 22 of the molten glass ribbon 20, via a through-hole 36 formed at a position corresponding to the longitudinal passage 30. Therefore, an edge portion 14A of the bath is communicated with the portion 14B on the side of the center of the bath via the circulation passage 38 and the through-hole 36. Accordingly, the molten tin 16 flowing from the outlet port 32 of the lateral passage 34 and being deflected by the side wall 15 of the bath 14 is partly introduced into the circulation passage 38 as indicated by an arrow mark I so as to be introduced to the portion 14B at a side of the center of the bath via the through-hole 36. The remaining part of the molten tin 16 flows to the edge portion 14A of the bath as indicated by an arrow mark J to be sucked into the inlet port 28 of the longitudinal passage 30.

As shown by broken lines in FIG. 1, there are a plurality of circulation passages 38 formed with predetermined distances in the direction of flow of the molten glass ribbon 20. The distance between adjacent circulation passages 38 is determined not only to prevent the occurrence of disturbance of the molten tin to be sucked at the inlet port 28 of the longitudinal passage 30 and to affect little influence on the recessed shape of the recessed portion 26 but also to render optimally the balance between the low rate of the molten tin flowing into the inlet port 28 of the longitudinal passage 30 from the edge portion 14A of the bath and the flow rate of the molten tin from the portion 14B at the side of the center of the bath, over the entire length of the inlet and to assure the retention of the edge portions. The circulation passages can be formed with intervals of, for example, from 0.3 to 1 m.

Control of the flow rate of the molten tin 16 may be determined previously before the operation of the flat glass manufacturing apparatus 10 or may be determined while the flat glass is produced after the initiation of the operation.

The gutter-like member 12 is so constructed that a part of molten tin in the molten tin 16 flowing from the outlet port 32 of the lateral passage 34 to the edge portion 14A of the bath is introduced to the portion 14B at the side of the center of the bath via the circulation passage 38 and the through-hole 36 due to a sucking force generated at the inlet port 28, and then is sucked into the inlet port 28. Accordingly, the flow quantity q1 of the molten tin 16 flowing from the edge portion 14A of the bath to the inlet port 28 is balanced with the flow quantity q2 of the molten tin 16 flowing from the portion 14B at the side of the center of the bath to the inlet port 28 (FIG. 4). In other words, the both flow quantities q1, q2 of the molten tin are substantially equal in the advancing direction of the molten glass ribbon 20, and recessed portions 26 suitable for retaining the edges of the ribbon are formed substantially uniformly in the bath surface 24 over the entire length of the gutter-like members 12 along the advancing direction of the molten glass ribbon 20, whereby the edges 22 of the molten glass ribbon can be retained stably in their entire lengths by the recessed portions 26. With this, it is possible to produce a flat glass satisfying the sheet thickness and flatness required for FPD.

There is a case that different temperatures are set for predetermined sections arranged in the flowing direction of the molten glass ribbon 20. In this case, at least one circulation passage 38 should be provided at a position corresponding to each section, whereby temperature distributions for these blocks can be maintained as desired so that flat glass of stable quality can be produced.

By using the above-mentioned flat glass manufacturing apparatus 10, a molten glass ribbon 20 is formed to a sheet thickness of 1.0<t≦1.5 times a predetermined sheet thickness t of from 0.1 to 1.1 mm, especially from 0.3 to 1.1 mm under a viscosity of molten glass ribbon 20 of log η≦5, and thereafter to the predetermined sheet thickness t under a viscosity of molten glass ribbon 20 of 5<log η≦7.65, preferably 5<log η≦7, as described before, whereby the flat glass of is the present invention can be produced easily.

The flat glass for FPD produced by such process has a sheet thickness of from 0.1 to 1.1 mm, especially from 0.3 to 1.1 mm and contains bubbles having a major axis of from 100 to 1,000 μm wherein the ratio of minor axis/major axis of the bubbles is 0.85 or greater. The reason why this flat glass can be produced will be explained.

We verified that when the viscosity of a molten glass ribbon was log η≦5, namely in a state of nearly liquid, bubbles contained in the molten glass ribbon maintained a state of substantially true round due to surface tension even though the ribbon was stretched in a direction of the lehr. However, in order to form the molten glass ribbon to a sheet thickness of from 0.1 to 1.1 mm, especially from 0.3 to 1.1 mm, it was necessary to pull it in a direction of the lehr while the molten glass ribbon was controlled with edge rollers so as to have a predetermined length in its width direction. For this, the molten glass ribbon should be stretched in a direction of the lehr while the width of the ribbon was secured in a state that the viscosity of the molten glass ribbon was log η>5, namely, in a state that the viscosity became high. As a result, the bubbles contained in the ribbon were also stretched to be in an elongated ball like a rugby ball. Namely, in the conventional process, when a molten glass ribbon having a viscosity of 5<log η≦7.65, preferably 5<log η≦7, i.e. a molten glass ribbon having an equilibrium thickness (7 mm) or more was stretched in a direction of the lehr while the ribbon was controlled in its width direction so that the ribbon have a sheet thickness of from 0.1 to 1.1 mm, especially from 0.3 to 1.1 mm, the bubbles in the glass ribbon became a shape of extremely elongated ball, i.e. the ratio of minor axis/major axis was less than 0.85, whereby they are apt to influence on visibility to picture images.

FIG. 5 is a diagram showing the relation between a viscosity (log η) and a sheet thickness (mm) of a molten glass ribbon in connection with a time axis (sec), according to in a conventional process for producing a flat glass, wherein the sheet thickness is a sheet thickness at a central portion in a direction of the width of glass ribbon.

With respect to FIG. 5, a flat glass is formed to have a predetermined sheet thickness of from 0.1 to 1.1 mm, especially from 0.3 to 1.1 mm by forming a molten glass ribbon to a sheet thickness of about 25 mm under a viscosity of log η=5, and thereafter, stretching the molten glass ribbon of about 25 mm thick in a direction of the lehr while the ribbon is retained in its width direction under a glass ribbon viscosity of 5<log η≦7.65, preferably 5<log η≦7. In this process, the shape of the bubbles was in an elongated ball whereby the visibility was easily affected.

In the flat glass manufacturing apparatus 10 according to the embodiment of the present invention, a molten glass ribbon 20 is formed to a sheet thickness of 1.0<t≦1.5 times a predetermined sheet thickness t of from 0.1 to 1.1 mm, especially from 0.3 to 1.1 mm under a molten glass ribbon viscosity of log η≦5, and thereafter, to the predetermined sheet thickness t under a molten glass ribbon viscosity of 5<log η≦7.65, preferably 5<log η≦7, as shown in FIG. 6. Accordingly, the shape of the bubbles assumes substantially true round.

Experiments were conducted on the visibility of flat glass for FPD produced as described above. A result of verification is shown below.

Degrees of visibility depend on the size and the shape of bubbles contained in a flat glass. With respect to the size of the bubbles, verification tests were conducted by visual check. When the size of bubble exceeded 1,000 μm in major axis, visibility to a picture image deteriorated because the size is too large in spite of a shape of bubble. On the other hand, when the size of bubble was less than 100 μm in major axis, influence on visibility to a picture image was less because the size of bubble was small in spite of a shape of bubble. This was also verified by a visual check. Accordingly, the size of bubble that may affect visibility to a picture image is from 100 to 1,000 μm in major axis.

Then, explanation will be made as to the shape of bubble.

FIG. 7 is a diagram showing the relation between a minor axis (μm) and a ratio of minor axis/major axis of the flat glass in connection with a major axis (μm) in the abscissa, produced according to a conventional process for producing a flat glass. In FIG. 7, ratios of minor axis/major axis distribute in a range of from 0.1 to 0.75. We have verified by visual check that the bubbles having a ratio of minor axis/major axis of less than 0.85 influenced easily on visibility.

FIG. 8 is a diagram showing the relation between a minor axis (μm) and a ratio of minor axis/major axis of a flat glass in connection with a major axis (μm) in the abscissa, produced according to an embodiment of the present invention. In FIG. 8, ratios of minor axis/major axis distribute in a range of from 0.85 to 1.0. We have verified by visual check that when the ratios of minor axis/major axis of bubble are 0.85 or greater, it is possible to improve influence on the visibility. Accordingly, in a group of flat glass having a sheet thickness of from 0.1 to 1.1 mm, especially from 0.3 to 1.1 mm, a flat glass according to an embodiment of the present invention, which contains bubbles having a major axis of from 100 to 1,000 μm wherein the ratio of minor axis/major axis is 0.85 or greater, less affects the visibility when used for FPD.

As the device for retaining the both side edges of the molten glass ribbon so as to oppose a contractive force due to the surface tension of the molten glass ribbon on a molten metal, the embodiment of the present invention employs the device for forming a flat glass wherein recessed portions 26 are formed in the bath surface 24 by sucking the molten tin 16 in its substantially vertical direction along the both side edges 22, 22 of the molten glass ribbon 20 so that the both side edges 22, 22 of the ribbon fit into the recessed portion 26 to be retained. However, this device is not limited to have such structure. For example, there is a device so constructed that molten metal is ejected from nozzles located in the molten metal toward the lower plane of both side edges of the molten glass ribbon so that the molten glass ribbon is stretched in a direction of its width by exerting a force to the width direction of the molten glass ribbon, namely, the molten glass ribbon is retained at both edge portions against a contractive force due to the surface tension of the ribbon on the molten metal. However, in order to produce stably a flat glass having a sufficient sheet thickness and flatness required for a flat glass for FPD, it is in particular preferred to employ the above-mentioned technique of retaining the molten glass ribbon by fitting the both edge portions 22, 22 in the recessed portions 26.

### INDUSTRIAL APPLICABILITY

The flat glass of the present invention has a sheet thickness of from 0.1 to 1.1 mm, especially from 0.3 to 1.1 mm and contains bubbles having a major axis of from 100 to 1,000 μm wherein the ratio of minor axis/major axis of the bubbles is 0.85 or greater. This flat glass can be used for FPD as a flat glass of high quality and less influence on visibility.

The entire disclosure of Japanese Patent Application No. 2005-114977 filed on Apr. 12, 2005 and Japanese Patent Application No. 2005-176682 filed on Jun. 16, 2005 including specification, claims, drawings and summary is incorporated herein by reference in its entirety.

What is claimed is:

1. A flat glass having a sheet thickness of from 0.1 to 1.1 mm and containing bubbles having a major axis of from 100 to 1,000 μm wherein the ratio of minor axis/major axis of the bubbles is 0.85 or greater.

2. A flat glass having a sheet thickness of from 0.3 to 1.1 mm and containing bubbles having a major axis of from 100 to 1,000 μm wherein the ratio of minor axis/major axis of the bubbles is 0.85 or greater.

3. A process for producing a flat glass which comprises forming a molten glass ribbon to a sheet thickness of over 1.0 to 1.5 times a predetermined sheet thickness t of from 0.1 to 1.1 mm under a molten glass ribbon viscosity of log η≦5, and thereafter forming the molten glass ribbon to the predetermined sheet thickness t under a molten glass ribbon viscosity of 5<log η≦7.65.

4. A process for producing a flat glass which comprises forming a molten glass ribbon to a sheet thickness of over 1.0 to 1.5 times a predetermined sheet thickness t of from 0.3 to 1.1 mm under a molten glass ribbon viscosity of log η≦5, and thereafter forming the molten glass ribbon to the predetermined sheet thickness t under a molten glass ribbon viscosity of 5<log η≦7.

5. The process for producing a flat glass according to claim 3, wherein a float method is utilized and wherein the process comprises pulling, toward a lehr, a molten glass ribbon retaining both side edges of the ribbon so as to oppose a contractive force due to the surface tension of the ribbon on a molten metal under a molten glass ribbon viscosity of log η≦5, to thereby form it to a sheet thickness of over 1.0 to 1.5 times the predetermined sheet thickness t of from 0.1 to 1.1 mm, and thereafter pulling the ribbon successively, toward the lehr, retaining the both side edges of the ribbon under a molten glass ribbon viscosity of from 5<log η≦7.65 to thereby form it to the predetermined thickness t.

6. The process for producing a flat glass according to claim 4, wherein a float method is utilized and wherein the process comprises pulling, toward a lehr, a molten glass ribbon retaining both side edges of the ribbon so as to oppose a contractive force due to the surface tension of the ribbon on a molten metal under a molten glass ribbon viscosity of log η≦5, to thereby form it to a sheet thickness of over 1.0 to 1.5 times the predetermined sheet thickness t of from 0.3 to 1.1 mm, and thereafter pulling the ribbon successively, toward the lehr, retaining the both side edges of the ribbon under a molten glass ribbon viscosity of from 5<log η≦7 to thereby form it to the predetermined thickness t.

7. The process for producing a flat glass according to claim 5, wherein in retaining the side edges of the ribbon, recessed portions are formed in the bath surface of the molten metal by sucking the molten metal in its substantially vertical direction along the both side edges of the molten glass ribbon so that the both side edges of the ribbon fit into the recessed portions.

8. The process for producing a flat glass according to claim 6, wherein in retaining the side edges of the ribbon, recessed portions are formed in the bath surface of the molten metal by sucking the molten metal in its substantially vertical direction along the both side edges of the molten glass ribbon so that the both side edges of the ribbon fit into the recessed portions.
